(19) United States
(12) Patent Application Publication
(10) Pub. No.: US 2014/0075103 A1
(43) Pub. Date: Mar. 13, 2014

(54) METHOD CAPABLE OF INCREASING PERFORMANCE OF A MEMORY AND RELATED MEMORY SYSTEM

(71) Applicant: Etron Technology, Inc., Hsinchu (TW)

(72) Inventors: Kai-Ping Wang, Hsinchu County (TW); Chung-Sheng Wang, New Taipei City (TW)

(73) Assignee: Etron Technology, Inc., Hsinchu (TW)

(21) Appl. No.: 14/023,463

(22) Filed: Sep. 10, 2013

Related U.S. Application Data
(60) Provisional application No. 61/699,441, filed on Sep. 11, 2012.

(51) Int. Cl. G06F 12/10; G06F 12/02

(52) U.S. Cl. CPC G06F 12/1036; G06F 12/0246
USPC 711/103; 711/206

(57) ABSTRACT

The present invention discloses a method capable of increasing performance of a memory, where a memory system applied to the method includes a memory and a controller, and a reserved space of the memory is used for storing a logic address/physical block mapping table. The method includes the controller reserving a plurality of physical blocks of the memory as a writing buffer pool; and the controller executing width writing operation or depth writing operation on a plurality of data and the writing buffer pool according to the logic address/physical block mapping table when the plurality of data are written to the memory. The logic address/physical block mapping table includes corresponding relationships between the plurality of physical blocks and a plurality of logic addresses.

### Cross Reference To Related Applications

This application claims the benefit of U.S. Provisional Application No. 61/699,441, filed on Sep. 11, 2012 and entitled “TLC Write Performance Improve,” the contents of which are incorporated herein by reference.

### BACKGROUND OF THE INVENTION

1. Field of the Invention

The present invention relates to a method capable of increasing performance of a memory and a related memory system, and particularly to a method and a related memory system that can utilize a controller to execute width writing operation or depth writing operation on a plurality of data of a host and a writing buffer pool of a memory according to a logic address/physical block mapping table to significantly reduce block merge operation executed by the controller.

2. Description of the Prior Art

Generally speaking, each flash memory is divided into a plurality of blocks. When a plurality of data are written to a flash memory, a host can transmit a plurality of logic addresses corresponding to the plurality of data to a controller according to the plurality of data. Then, the controller can write the plurality of data to a plurality of corresponding blocks of the flash memory according to a logic address/physical block mapping table and the plurality of logic addresses corresponding to the plurality of data.

During the controller writing the plurality of data to the plurality of corresponding blocks of the flash memory, the controller can execute block merge operation on part blocks of the plurality of corresponding blocks to release the part blocks of the plurality of corresponding blocks, so writing performance of the flash memory is decreased. Therefore, how to reduce the block merge operation executed by the controller is an important issue of increasing writing performance of the flash memory.

### SUMMARY OF THE INVENTION

An embodiment provides a method capable of increasing performance of a memory, wherein a memory system applied to the method includes a memory and a controller, and a reserved space of the memory is used for storing a logic address/physical block mapping table. The method includes the controller reserving a plurality of physical blocks of the memory as a writing buffer pool, wherein the logic address/physical block mapping table comprises corresponding relationships between the plurality of physical blocks and a plurality of logic addresses; and the controller executing width writing operation or depth writing operation on a plurality of data and the writing buffer pool according to the logic address/physical block mapping table when the plurality of data are written to the memory.

Another embodiment provides a memory system capable of increasing performance of a memory. The memory system includes a memory and a controller. A reserved space of the memory is used for storing a logic address/physical block mapping table. The controller is used for reserving a plurality of physical blocks of the memory as a writing buffer pool, and executing width writing operation or depth writing operation on a plurality of data and the writing buffer pool according to the logic address/physical block mapping table when the plurality of data are written to the memory. The logic address/physical block mapping table includes corresponding relationships between the plurality of physical blocks and a plurality of logic addresses.

The present invention provides a method capable of increasing performance of a memory and a memory system capable of increasing performance of a memory. The method and the memory system utilize a controller to execute width writing operation or depth writing operation on a plurality of data of a host and a writing buffer pool of the memory according to a logic address/physical block mapping table when the plurality of data of the host are written to the memory to significantly reduce block merge operation executed by the controller. Thus, compared to the prior art, because the present invention can utilize the controller to execute the width writing operation or the depth writing operation on the plurality of data of the host and the writing buffer pool of the memory according to the logic address/physical block mapping table to significantly reduce the block merge operation executed by the controller, the present invention can significantly increase performance of the memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory system capable of increasing performance of a memory according to an embodiment.

FIG. 2 is a flowchart illustrating a method capable of increasing performance of a memory according to another embodiment.

FIG. 3 is a diagram illustrating width writing operation.

FIG. 4 is a diagram illustrating depth writing operation.

FIG. 5 is a diagram illustrating garbage block operation.

FIG. 6 is a diagram illustrating block merge operation.

### DETAILED DESCRIPTION

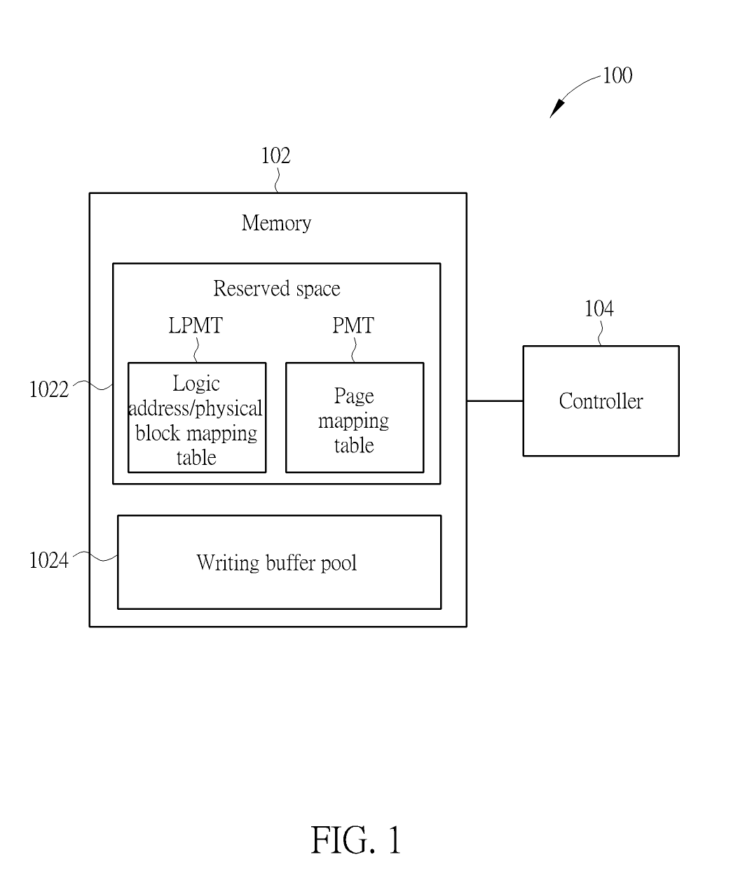

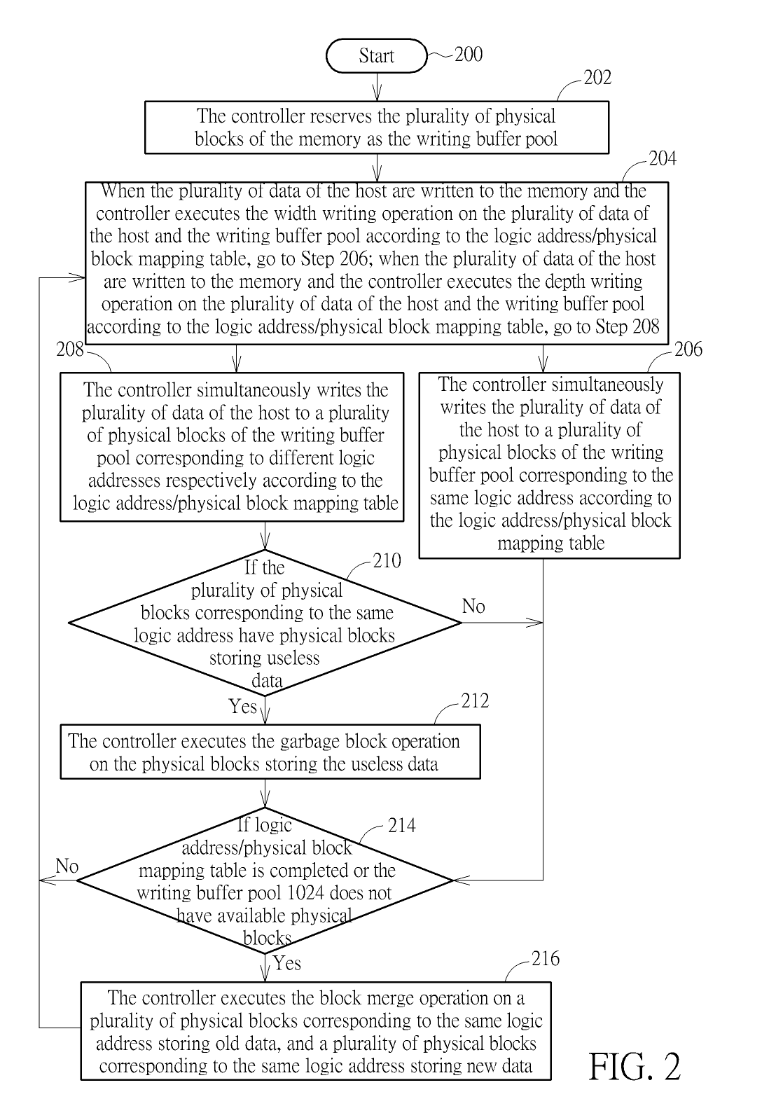

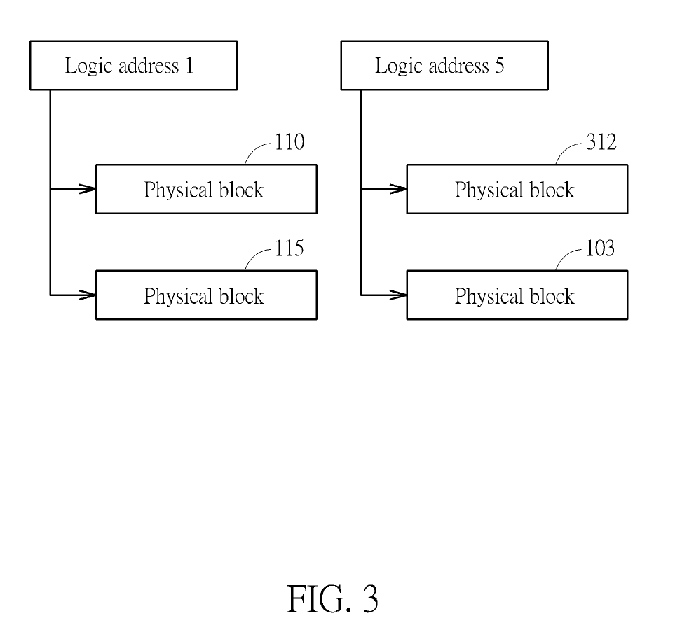

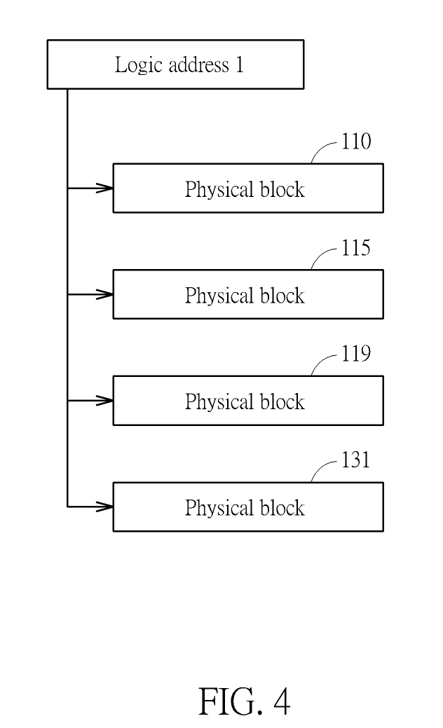

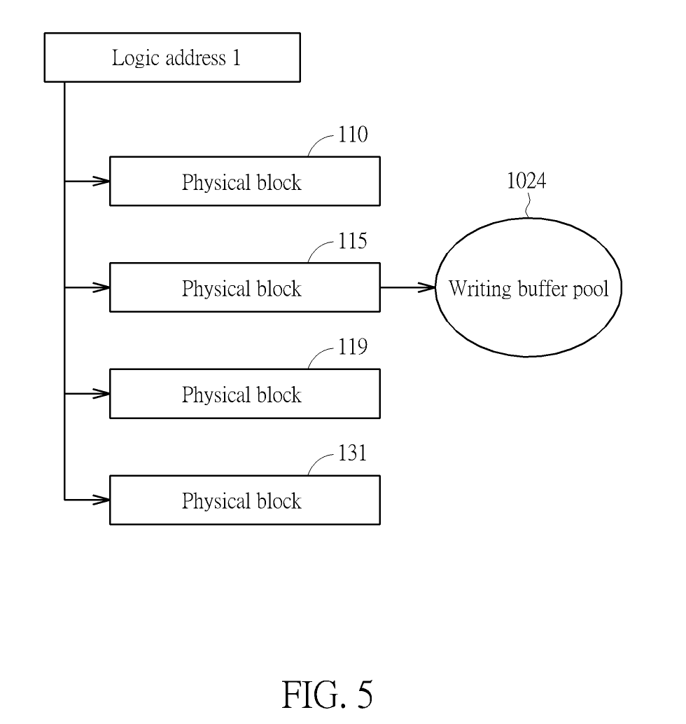

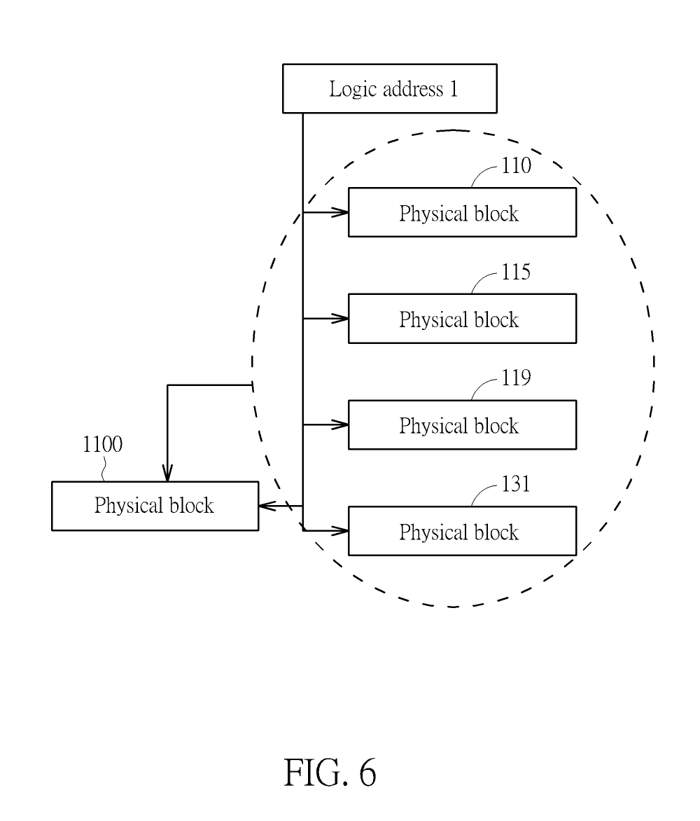

Please refer to FIG. 1 to FIG. 6. FIG. 1 is a diagram illustrating a memory system 100 capable of increasing performance of a memory according to an embodiment, FIG. 2 is a flowchart illustrating a method capable of increasing performance of a memory according to another embodiment, FIG. 3 is a diagram illustrating width writing operation, FIG. 4 is a diagram illustrating depth writing operation, FIG. 5 is a diagram illustrating garbage block operation, and FIG. 6 is a diagram illustrating block merge operation. As shown in FIG. 1, the memory system 100 includes a memory 102 and a controller 104, wherein the memory 102 is a flash memory or a NAND flash memory. A reserved space 1022 of the memory 102 is used for storing a logic address/physical block mapping table LPMT. As shown in FIG. 1, the controller 104 is used for reserving a plurality of physical blocks of the memory 102 as a writing buffer pool 1024, and the controller 104 executes corresponding operation (e.g. width writing operation or depth writing operation) on a plurality of data of a host according to the logic address/physical block mapping table LPMT when the plurality of data of the host are written to the memory 102, wherein the logic address/physical block mapping table LPMT includes corresponding relationships between the plurality of physical blocks of the writing buffer pool 1024 and a plurality of logic addresses. In addition, the method in FIG. 2 is illustrated using the memory system 100 in FIG. 1. Detailed steps are as follows:

Step 200: Start.

Step 202: The controller 104 reserves the plurality of physical blocks of the memory 102 as the writing buffer pool 1024.

Step 204: When the plurality of data of the host are written to the memory 102 and the controller 104 executes the width writing operation on the plurality of data of the host and the writing buffer pool 1024 according to the logic address/physical block mapping table LPMT, go to Step 206; when the plurality of data of the host are written to the memory 102 and the controller 104 executes the depth writing operation on the plurality of data of the host and the writing buffer pool 1024 according to the logic address/physical block mapping table LPMT, go to Step 208.

Step 206: The controller 104 simultaneously writes the plurality of data of the host to a plurality of physical blocks of the writing buffer pool 1024 corresponding to different logic addresses respectively according to the logic address/physical block mapping table LPMT, go to Step 214.

Step 208: The controller 104 simultaneously writes the plurality of data of the host to a plurality of physical blocks of the writing buffer pool 1024 corresponding to the same logic address according to the logic address/physical block mapping table LPMT.

Step 210: If the plurality of physical blocks corresponding to the same logic address have physical blocks storing useless data; if yes, go to Step 212; if no, go to Step 214.

Step 212: The controller 104 executes the garbage block operation on the physical blocks storing the useless data, go to Step 214.

Step 214: If logic address/physical block mapping table LPMT is completed or the writing buffer pool 1024 does not have available physical blocks; if yes, go to Step 216; if no, go to Step 204.

Step 216: The controller 104 executes the block merge operation on a plurality of physical blocks corresponding to the same logic address storing old data, and a plurality of physical blocks corresponding to the same logic address storing new data, go to Step 204.

In Step 202, the controller 104 reserves physical blocks of multiple level cell physical blocks and triple level cell physical blocks of the memory 102 only utilizing single level cell pages as the writing buffer pool 1024. In Step 204, when the plurality of data of the host are written to the memory 102, the host can generate and output logic addresses corresponding to the plurality of data to the controller 104. Therefore, the controller 104 executes the width writing operation or the depth writing operation on the plurality of data of the host according to the logic address/physical block mapping table LPMT. In Step 206, the controller 104 simultaneously writes the plurality of data of the host to the plurality of physical blocks of the writing buffer pool 1024 corresponding to different logic addresses respectively according to the logic address/physical block mapping table LPMT. As shown in FIG. 3, according to the logic address/physical block mapping table LPMT, physical blocks 110, 115 of the writing buffer pool 1024 correspond to a logic address 1 and physical blocks 312, 103 of the writing buffer pool 1024 correspond to a logic address 5, wherein the physical blocks 110, 312 store old data, and new data can be written to the physical blocks 115, 103. Therefore, the controller 104 can simultaneously write the plurality of data of the host to the physical block 115 corresponding to the logic address 1 and the physical block 103 corresponding to the logic address 5 according to the logic address/physical block mapping table LPMT, and does not execute the block merge operation on the physical blocks 110, 115 (corresponding to the logic address 1) and the physical blocks 103, 312 (corresponding to the logic address 5) until the logic address/physical block mapping table LPMT is completed or the writing buffer pool 1024 does not have the available physical blocks. In addition, when the controller 104 simultaneously writes the plurality of data of the host to the physical block 115 and the physical block 103 of the writing buffer pool 1024 according to the logic address/physical block mapping table LPMT, the controller 104 can write the plurality of data of the host to corresponding storing pages of the physical block 115 and the physical block 103 according to a page mapping table PMT further included in the reserved space 1022. In addition, FIG. 3 is only used for describing the controller 104 to execute the width writing operation, that is, the present invention is not limited to numbers, quantities, and logic addresses of physical blocks in FIG. 3.

In Step 208, the controller 104 simultaneously writes the plurality of data of the host to the plurality of physical blocks of the writing buffer pool 1024 corresponding to the same logic address according to the logic address/physical block mapping table LPMT. As shown in FIG. 4, according to the logic address/physical block mapping table LPMT, physical blocks 110, 115, 119, 131 of the writing buffer pool 1024 correspond to a logic address 1, wherein the physical block 110 stores old data and new data can be written to the physical blocks 115, 119, 131. Therefore, the controller 104 can simultaneously write the plurality of data of the host to the physical blocks 115, 119, 131 of the writing buffer pool 1024 according to the logic address/physical block mapping table LPMT. As shown in FIG. 4, the physical blocks 115, 119 are full of new data and new data can be continuously written to the physical block 131, but the controller 104 does not executes the block merge operation on the physical blocks 110, 115, 119, 131 until the logic address/physical block mapping table LPMT is completed or the writing buffer pool 1024 does not have available physical blocks. In addition, FIG. 4 is only used for describing the controller 104 to execute the depth writing operation, that is, the present invention is not limited to numbers, quantities, and logic addresses of physical blocks in FIG. 4.

In Step 212, when the controller 104 executes the depth writing operation on the plurality of data of the host according to the logic address/physical block mapping table LPMT, the controller 104 can execute the garbage block operation on physical blocks storing useless data to release the physical blocks storing the useless data to the writing buffer pool 1024. As shown in FIG. 5, according to the logic address/physical block mapping table LPMT, physical blocks 110, 115, 119, 131 of the writing buffer pool 1024 correspond to a logic address 1, wherein the physical block 110 stores old data, the physical block 115 stores useless data, and new data can be written to the physical blocks 119, 131. Therefore, the controller 104 can simultaneously write the plurality of data of the host to the physical blocks 119, 131 of the writing buffer pool 1024 according to the logic address/physical block mapping table LPMT, and execute the garbage block operation on the physical block 115. As shown in FIG. 5, the physical block 119 is full of new data, new data can be continuously written to the physical block 131, and the physical block 115 is released to the writing buffer pool 1024. In addition, FIG. 5 is only used for describing the controller 104 to execute the garbage block operation, that is, the present invention is not limited to numbers, quantities, and logic addresses of physical blocks in FIG. 5.

In Step 216, when the logic address/physical block mapping table LPMT is completed or the writing buffer pool 1024 does not have available physical blocks, the controller 104 can execute the block merge operation on the plurality of physical blocks corresponding to the same logic address storing old data, and the plurality of physical blocks corresponding to the same logic address storing new data to release the plurality of physical blocks corresponding to the same logic address storing store old data, and the plurality of physical blocks corresponding to the same logic address storing store new data to the writing buffer pool 1024. As shown in FIG. 6, according to the logic address/physical block mapping table LPMT, physical blocks 110, 115, 119, 131, 1100 of the writing buffer pool 1024 correspond to a logic address 1, wherein the physical block 110 stores old data, new data can be written to the physical blocks 115, 119, 131. Therefore, the controller 104 can simultaneously write the plurality of data of the host to the physical blocks 115, 119, 131 of the writing buffer pool 1024 according to the logic address/physical block mapping table LPMT. As shown in FIG. 6, the physical blocks 115, 119 are full of new data and new data can be continuously written to the physical block 131. However, meanwhile, the logic address/physical block mapping table LPMT is completed and the writing buffer pool 1024 does not have available physical blocks. Therefore, the controller 104 executes the block merge operation on the physical blocks 110, 115, 119, 131 and stores data stored in the physical blocks 110, 115, 119, 131 to the physical block 1100 to release the physical blocks 110, 115, 119, 131 to the writing buffer pool 1024 and a part of the logic address/physical block mapping table LPMT. Because the controller 104 executes the block merge operation on the physical blocks 110, 115, 119, 131 after the logic address/physical block mapping table LPMT is completed and the writing buffer pool 1024 does not have available physical blocks, the block merge operation can be significantly reduced. In addition, FIG. 6 is only used for describing the controller 104 to execute the garbage block operation, that is, the present invention is not limited to numbers, quantities, and logic addresses of physical blocks in FIG. 6.

To sum up, the method capable of increasing performance of the memory and the memory system capable of increasing performance of the memory utilize the controller to execute width writing operation or depth writing operation on a plurality of data of the host and the writing buffer pool of the memory according to the logic address/physical block mapping table when the plurality of data of the host are written to the memory to significantly reduce block merge operation executed by the controller. Thus, compared to the prior art, because the present invention can utilize the controller to execute the width writing operation or the depth writing operation on the plurality of data of the host and the writing buffer pool of the memory according to the logic address/physical block mapping table to significantly reduce the block merge operation executed by the controller, the present invention can significantly increase performance of the memory.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method capable of increasing performance of a memory, wherein a memory system applied to the method comprises a memory and a controller, and a reserved space of the memory is used for storing a logic address/physical block mapping table, the method comprising:
the controller reserving a plurality of physical blocks of the memory as a writing buffer pool, wherein the logic address/physical block mapping table comprises corresponding relationships between the plurality of physical blocks and a plurality of logic addresses; and
the controller executing width writing operation or depth writing operation on a plurality of data and the writing buffer pool according to the logic address/physical block mapping table when the plurality of data are written to the memory.

2. The method of claim 1, wherein the controller executing the width writing operation on the plurality of data and the writing buffer pool according to the logic address/physical block mapping table when the plurality of data are written to the memory comprises:
the controller simultaneously writing the plurality of data to a plurality of physical blocks of the writing buffer pool corresponding to different logic addresses respectively according to the logic address/physical block mapping table;
wherein when the controller executes the width writing operation on the plurality of data and the writing buffer pool according to the logic address/physical block mapping table, the controller does not execute block merge operation on a plurality of first physical blocks storing old data and a plurality of second physical blocks storing new data until the logic address/physical block mapping table is completed or the writing buffer pool does not have available physical blocks, wherein the plurality of first physical blocks and the plurality of second physical blocks correspond to a first logic address.

3. The method of claim 2, further comprising:
when the logic address/physical block mapping table is completed or the writing buffer pool does not have the available physical blocks, the controller executing the block merge operation on the plurality of first physical blocks and the plurality of second physical blocks, and storing data stored in the plurality of first physical blocks and the plurality of second physical blocks to a third physical block to release the plurality of first physical blocks, the plurality of second physical blocks, and a part of the logic address/physical block mapping table, wherein the third physical block corresponds to the first logic address.

4. The method of claim 1, wherein the controller executing the depth writing operation on the plurality of data and the writing buffer pool according to the logic address/physical block mapping table when the plurality of data are written to the memory comprises:
the controller simultaneously writing the plurality of data to a plurality of fourth physical blocks of the writing buffer pool according to the logic address/physical block mapping table, wherein the plurality of fourth physical blocks correspond to a second logic address;
wherein the controller does not execute block merge operation on fourth physical blocks of the plurality of fourth physical blocks for storing old data and fourth physical blocks of the plurality of fourth physical blocks for storing new data until the logic address/physical block mapping table is completed or the writing buffer pool does not have available physical blocks.

5. The method of claim 4, further comprising:
when the logic address/physical block mapping table is completed or the writing buffer pool does not have the available physical blocks, the controller executing the block merge operation on the fourth physical blocks for storing the old data and the fourth physical blocks for storing the new data, and storing the old data and the new data in a fifth physical block to release the fourth physical blocks for storing the old data, the fourth physical blocks for storing the new data, and a part of the logic address/physical block mapping table, wherein the fifth physical block corresponds to the second logic address.

6. The method of claim 4, further comprising:
the controller executing garbage block operation on physical blocks corresponding to the second logic address for storing useless data to release the physical blocks corresponding to the second logic address for storing the useless data to the writing buffer pool when the controller simultaneously writes the plurality of data to the plurality of fourth physical blocks.

7. The method of claim 1, wherein the plurality of physical blocks are physical blocks of multiple level cell physical blocks and triple level cell physical blocks of the memory utilizing single level cell pages.

8. The method of claim 1, wherein the memory is a flash memory or a NAND flash memory.

9. A memory system capable of increasing performance of a memory, the memory system comprising:
a memory, wherein a reserved space of the memory is used for storing a logic address/physical block mapping table; and
a controller for reserving a plurality of physical blocks of the memory as a writing buffer pool, and executing width writing operation or depth writing operation on a plurality of data and the writing buffer pool according to the logic address/physical block mapping table when the plurality of data are written to the memory;
wherein the logic address/physical block mapping table comprises corresponding relationships between the plurality of physical blocks and a plurality of logic addresses.

10. The memory system of claim 9, wherein the controller executing the width writing operation on the plurality of data and the writing buffer pool according to the logic address/physical block mapping table when the plurality of data are written to the memory is the controller simultaneously writing the plurality of data to a plurality of physical blocks of the writing buffer pool corresponding to different logic addresses respectively according to the logic address/physical block mapping table; wherein when the controller executes the width writing operation on the plurality of data and the writing buffer pool according to the logic address/physical block mapping table, the controller does not execute block merge operation on a plurality of first physical blocks for storing old data and a plurality of second physical blocks for storing new data until the logic address/physical block mapping table is completed or the writing buffer pool does not have available physical blocks.

11. The memory system of claim 10, wherein when the logic address/physical block mapping table is completed or the writing buffer pool does not have the available physical blocks, the controller executes the block merge operation on the plurality of first physical blocks and the plurality of second physical blocks, and stores data stored in the plurality of first physical blocks and the plurality of second physical blocks to a third physical block to release the plurality of first physical block, the plurality of second physical blocks, and a part of the logic address/physical block mapping table, wherein the third physical block corresponds to the first logic address.

12. The memory system of claim 9, wherein the controller executing the depth writing operation on the plurality of data and the writing buffer pool according to the logic address/physical block mapping table when the plurality of data are written to the memory is the controller simultaneously writing the plurality of data to a plurality of fourth physical blocks of the writing buffer pool according to the logic address/physical block mapping table, wherein the plurality of fourth physical blocks correspond to a second logic address; wherein the controller does not execute block merge operation on fourth physical blocks of the plurality of fourth physical blocks for storing old data and fourth physical blocks of the plurality of fourth physical blocks for storing new data until the logic address/physical block mapping table is completed or the writing buffer pool does not have available physical blocks.

13. The memory system of claim 12, wherein when the logic address/physical block mapping table is completed or the writing buffer pool does not have the available physical blocks, the controller executes the block merge operation on the fourth physical blocks storing the old data and the fourth physical blocks storing the new data, and storing the old data and the new data in a fifth physical block to release the fourth physical blocks for storing the old data, the fourth physical blocks for storing the new data, and a part of the logic address/physical block mapping table, wherein the fifth physical block corresponds to the second logic address.

14. The memory system of claim 12, wherein when the controller simultaneously writes the plurality of data to the plurality of fourth physical blocks, the controller executes garbage block operation on physical blocks corresponding to the second logic address for storing useless data to release the physical blocks corresponding to the second logic address for storing the useless data to the writing buffer pool.

15. The memory system of claim 9, wherein the plurality of physical blocks are physical blocks of multiple level cell physical blocks and triple level cell physical blocks of the memory utilizing single level cell pages.

16. The memory system of claim 9, wherein the memory is a flash memory or a NAND flash memory.
